(19) United States
(12) Patent Application Publication
(10) Pub. No.: US 2020/0118569 A1
(43) Pub. Date: Apr. 16, 2020

(54) CONFERENCE SOUND BOX AND CONFERENCE RECORDING METHOD, APPARATUS, SYSTEM AND COMPUTER STORAGE MEDIUM

(71) Applicant: Shenzhen Oceanwing Smart Innovations Technology Co., Ltd, Shenzhen City (CN)

(72) Inventor: Ang XIAO, Shenzhen City (CN)

(21) Appl. No.: 16/568,179

(22) Filed: Sep. 11, 2019

(30) Foreign Application Priority Data
Oct. 12, 2018 (CN) 201811191316.8

(51) Int. Cl. G10L 15/26; G10L 15/22; G10L 15/30

(52) U.S. Cl. CPC G10L 15/265; H04L 67/10; G10L 15/30; G10L 15/22

(57) ABSTRACT

Embodiments of the present disclosure provide a conference sound box, a conference recording method, apparatus, system, and a computer storage medium. The conference recording method may include: receiving conference audio data copied by the conference sound box; sending the conference audio data to a voice-to-text server for text conversion; and receiving texts from the voice-to-text server. In this way, the conference sound box, the conference recording method, apparatus, system, and the computer storage medium according to the embodiments of the present disclosure could conveniently realize text conversion of conference voices and automatic conference recording, thereby improving work efficiency and reducing resource waste.

### CROSS REFERENCE TO RELATED APPLICATIONS

The present application claims foreign priority of Chinese Patent Application No. 201811191316.8, in the title of “CONFERENCE SOUND BOX AND CONFERENCE RECORDING METHOD, APPARATUS, SYSTEM AND COMPUTER STORAGE MEDIUM”, filed on Oct. 12, 2018 in the National Intellectual Property Administration of China, the entire contents of which are hereby incorporated by reference in their entireties.

### TECHNICAL FIELD

Embodiments of the present disclosure relate to the technical field of conference recording, particularly to a conference sound box, a conference recording method, apparatus, system and a computer storage medium.

### BACKGROUND

Currently, with the development of commerce and information technology, commercial communication using information technology is becoming increasingly frequent. It is a common means of communication to hold a two-party or multi-party telephone/video conference through voice conference software (e.g., Skype) or a conference system. During the conference, it is needed in many cases to make a conference summary such that a document is formed to reach conference decisions and consensus. In this scenario, the conference summary generally requires manual recording or audio recording followed by manual transcription, which, however, greatly reduces work efficiency of the information era and wastes a lot of resources, to the disadvantage of environmental protection and green office.

Therefore, a conference sound box, a conference recording method, apparatus, system and a computer storage medium are proposed to solve the above problems.

### SUMMARY OF THE DISCLOSURE

In consideration of the above problems, the present invention has been proposed. The present disclosure provides a conference sound box, a conference recording method, apparatus, system and a computer storage medium, which can conveniently realize text conversion of conference voices via a voice-to-text server to achieve automatic conference recording, thereby improving work efficiency and reducing resource waste.

According to a first aspect of the present disclosure, a conference sound box capable of communicating to a conference recording device may be provided. The conference sound box may include an audio acquisition module configured to acquire conference audio data; an audio playing module configured to play the conference audio data; a processor configured to process the conference audio data and to copy the processed conference audio data; and a communication interface configured to send the processed conference audio data to the conference recording device. The conference recording device may be configured to send the processed conference audio data to a voice-to-text server for text conversion and to receive texts from the voice-to-text server to implement conference recording.

In an embodiment of the present disclosure, the conference sound box may communicate to the conference recording device via Bluetooth, Wifi or USB.

According to a second aspect of the present disclosure, a conference recording method using a conference sound box according to the first aspect of the present disclosure may be provided. The method may include receiving conference audio data copied by the conference sound box; sending the conference audio data to a voice-to-text server for text conversion; and receiving texts from the voice-to-text server.

In an embodiment of the present disclosure, the method may further include processing the texts. The processing may include text correction and/or typesetting

In an embodiment of the present disclosure, the processing may further include extracting key words or key segments from the texts to obtain key contents of the conference.

In an embodiment of the present disclosure, the method may further include: analyzing the conference audio data to distinguish and mark audio data of different conference participants.

In an embodiment of the present disclosure, the method may further include: marking texts into which the audio data of different conference participants has been converted.

According to a third aspect of the present disclosure, a conference recording apparatus may be provided. The conference recording apparatus may include one or more processors; a memory configured to store one or more programs, wherein the one or more processors may be caused to implement a conference recording method according to the second aspect of the present disclosure when the one or more programs are executed by the one or more processors.

According to a fourth aspect of the present disclosure, a conference recording system may be provided. The conference recording system may include a conference sound box configured to acquire and play conference audio data and to copy the conference audio data; a conference recording apparatus configured to receive the conference audio data from the conference sound box, to send the conference audio data to a voice-to-text server for text conversion, and to receive texts from the voice-to-text server to implement conference recording.

According to a fifth aspect of the present disclosure, a computer storage medium may be provided. The computer storage medium may store a computer program, the program, when executed by a processor, may implement a conference recording method according to the second aspect of the present disclosure.

According to the conference sound box, the conference recording method, apparatus, system and the computer storage medium of the present disclosure, conference audio data copied by a conference sound box is uploaded to a voice-to-text server for text conversion, and by means of the voice-to-text server, it is possible to conveniently realize text conversion of conference voices to achieve automatic conversion and recording of the conference voices, which improves work efficiency and reduces resource waste.

### BRIEF DESCRIPTION OF THE DRAWINGS

Embodiments of the present disclosure will be detailed below in conjunction with the accompanying drawings, such that the foregoing and other objects, features and advantages of the present disclosure will become more evident. The accompanying drawings are employed to further explain the embodiments of the present disclosure, form a part of the description, and are used together with the embodiments of the present disclosure to interpret the present disclosure, without constituting limitations on the present disclosure. In the accompanying drawings, same reference signs typically represent same or similar components or steps.

FIG. 1 is a schematic block diagram of a conference sound box according to an embodiment of the present disclosure.

FIG. 2 is a schematic flow diagram of a conference recording method according to an embodiment of the present disclosure.

FIG. 3 is a schematic block diagram of a conference recording apparatus according to an embodiment of the present disclosure.

FIG. 4 is a schematic block diagram of a conference recording apparatus according to an embodiment of the present disclosure.

FIG. 5 is a schematic diagram of a use circumstance of a conference recording system according to an embodiment of the present disclosure.

FIG. 6 is a schematic diagram of another use circumstance of a conference recording system according to an embodiment of the present disclosure.

### DETAILED DESCRIPTION

In the following description, numerous specific details are set forth to provide a more thorough understanding of the present disclosure. However, it is apparent to those skilled in the art that the embodiments of the present disclosure can be implemented without one or more of these details. In other examples, some of the technical features well known in the art are not described to avoid confusion with the embodiments of the present disclosure.

It should be understood that, the present disclosure can be implemented in various forms and should not be construed as being limited to the embodiments set forth herein. On the contrary, these embodiments are provided to make the present disclosure thorough and complete, and totally transmit the scope of the present disclosure to those skilled in the art. In the accompanying drawings, sizes and relative sizes of components, elements and the like may be exaggerated for the sake of clarity. Throughout the present disclosure, same reference numbers represent same elements.

In order to make the objects, technical solutions and advantages of the present disclosure more evident, exemplary embodiments according to the present disclosure will be detailed below with reference to the accompanying drawings. Evidently, the embodiments described are only a part of the embodiments of the present disclosure, rather than all embodiments of the present disclosure. It should be understood that, the present disclosure is not limited by the embodiments described herein. On the basis of the embodiments described in the present disclosure, all other embodiments attained by those skilled in the art without expending inventive labor shall fall within the protection scope of the present disclosure.

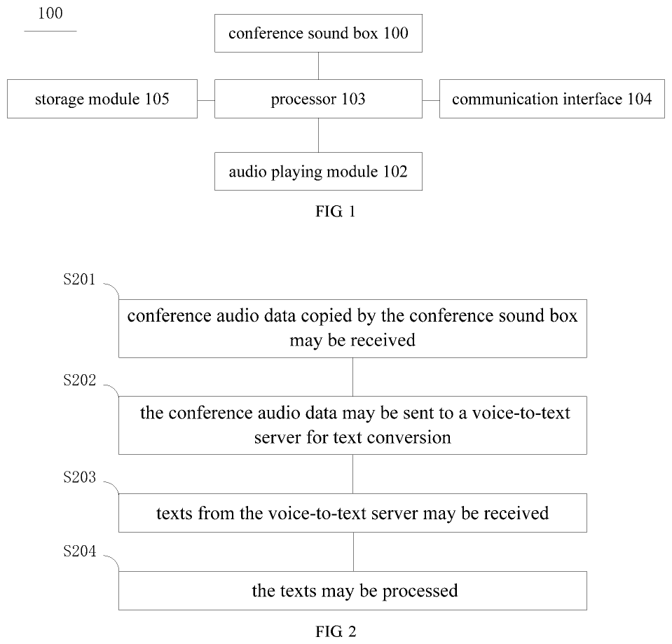

FIG. 1 is a schematic block diagram of a conference sound box according to an embodiment of the present disclosure. As shown in FIG. 1, a conference sound box 100 provided according to an embodiment of the present disclosure may include an audio acquisition module 101, an audio playing module 102, a processor 103, a communication interface 104, and a storage module 105.

The audio acquisition module 101 may be configured to acquire conference audio data. Exemplarily, the audio acquisition module 101 could be any type of microphone or microphone array and a corresponding circuit. The audio acquisition module 101 could include one or more microphones. Moreover, when a plurality of microphones are included, the plurality of microphones may be arranged at different positions of the conference sound box to realize audio acquisition in different directions or perform audio acquisition from different directions, thereby making it possible to improve audio acquisition quality and facilitating subsequent processing of the acquired conference audio data, for example, performing noise reduction processing or performing orientation weight judgment and weighted processing.

The audio playing module 102 may be configured to play conference audio data. Exemplarily, the audio playing module 102 could be any type of loudspeaker unit and a corresponding circuit, and the number of loudspeaker units could be one or more. The audio playing module 102 could play conference audio data received from other apparatus, for example, a conference system or other apparatus running voice conference software. It should be understood that, in the present embodiment, the conference audio data may include conference audio data created by all parties participating in the conference, i.e., may include conference audio data acquired by the conference sound box, and also may include conference audio data of other conference participants transmitted to the conference sound box.

The processor 103 may be configured to process the conference audio data. Exemplarily, processing of the conference audio data may include any required audio data processing, such as beamforming processing, noise reduction processing, enhanced amplification processing, and the like. In addition, the processor 103 may further copy the conference audio data passing through the conference sound box, and the copying operation may be performed before the conference audio data processing or after the conference audio data processing. The processor 103, after completing the processing of the conference audio data, may copy the processed conference audio data. The processor 103 could be implemented in a number of different ways. For example, a processor 103 may include one or more embedded processors, processor cores, microprocessors, logic circuits, hardware finite state machines (FSMs), digital signal processors (DSPs), or combinations thereof.

The communication interface 104 may be configured to implement communication and data transmission between the conference sound box and other apparatuses, such as a conference recording device/apparatus and a conference device/system. For example, in the present embodiment, the communication interface 104 may be configured to receive and send the conference audio data, and to send the processed conference audio data to the conference recording device. The communication interface 104 may include one or more wired or wireless communication interfaces, for example, a communication interface network interface card, a wireless modem, or a wired modem. In an application, the communication interface 104 may be a WiFi modem. In other applications, the communication interface 104 may be a 3G modem, a 4G modem, an LTE modem, a Bluetooth component, a radio frequency receiver, a USB interface, an antenna, or combinations thereof.

The storage module 105 may be capable of storing software, data, logs, or combinations thereof. Exemplarily, the storage module 105 may be configured to store the conference audio data copied by the processor 103. The storage module 105 could be an internal memory or an external memory. For example, the storage module 105 could be a volatile memory, for example, a static random access memory (SRAM), or a non-volatile memory, for example, a non-volatile random access memory (NVRAM), a flash memory or a disk memory.

Furthermore, the conference sound box could communicate to the conference recording device which may be configured to send the processed conference audio data to a voice-to-text server for text conversion and to receive texts from the voice-to-text server to implement conference recording.

Exemplarily, the conference sound box 100 may communicate to the conference recording device via Bluetooth, Wifi or USB.

The conference sound box according to the embodiments may send the copied conference audio data to the conference recording device by communicating with the conference recording device, so that the conference recording device performs subsequent processing to realize conference recording.

The present disclosure further provides a conference recording method using a conference sound box according to the embodiments. A conference recording method according to an embodiment of the present disclosure will be described below in conjunction with FIG. 2. FIG. 2 is a schematic flow diagram of a conference recording method according to an embodiment of the present disclosure. The conference recording method described in FIG. 2 may include the following operations or actions.

Block S201: conference audio data copied by the conference sound box may be received. Exemplarily, conference audio data copied by the conference sound box may be received by the conference recording device through communication connection to the conference sound box. Exemplarily, the conference audio data copied by the conference sound box may be transmitted through SPP (Bluetooth Serial Port Protocol), USB (Universal Serial Bus) or Wifi (Wireless Fidelity).

Block S202: the conference audio data may be sent to a voice-to-text server for text conversion.

After receiving the conference audio data copied by the conference sound box, the conference recording device may send the conference audio data to a voice-to-text server for text conversion. Exemplarily, the conference audio data may be sent to the voice-to-text server for text conversion through any type of network communication manner such as a wired network, a wireless network, a mobile communication network or the like. Exemplarily, the voice-to-text server could be disposed locally or in the cloud. Exemplarily, the voice-to-text server may be implemented based on an ASR (Automatic Speech Recognition technology) engine. The conference audio data copied by the conference sound box could be converted into texts via the voice-to-text server. Further, the voice-to-text server may also perform processing of the converted texts, such as error correction, typesetting, marking (highlighting), and the like.

Block S203: texts from the voice-to-text server may be received. Texts from the voice-to-text server may be received via communication to the voice-to-text server.

Block S204: the texts may be processed.

As an example, the processing may include text correction and/or typesetting. The text error correction and/or typesetting could be implemented based on a local text processing engine or a third-party text processing engine. As another example, the processing may further refer to extracting key words or key segments from the texts to obtain key contents of the conference. The key words or key segments could be implemented via manual and/or automatic operations, for example, the key words could be inputted by the user. The extraction of the key words and the key segments may be performed automatically.

In some embodiments, it should be understood that, when the voice-to-text server performs partial text processing, for example, typesetting or error correction. The operation of S204 may not include the processing of typesetting or error correction any more. For example, the operation of S204 may merely performing extraction of key words or key segments from the texts to obtain the key contents of the conference. Of course, in other embodiments, it may be also possible to perform text correction and/or typesetting again.

In some embodiments, the conference recording method may further include the operations that the conference audio data may be analyzed, such that audio data of different conference participants could be distinguished and marked, and further, texts into which the audio data of different conference participants has been converted may be marked. Exemplarily, by performing analysis of voiceprint, voice frequency, etc. of the audio data, it may be possible to distinguish whether each segment of audio in the conference audio data belongs to a same conference participant, and then to mark each segment of audio; and after the segment of audio is converted into texts, the segment of texts may be also marked, so that the user could make a distinction between speeches of different conference participants. It should be understood that, the processing could be realized in an apparatus that implements the conference recording method, or could be realized via a voice-to-text server.

In some embodiments, the conference recording method may further include operation that the texts from the voice-to-text server may be displayed in real time. After the texts of the voice-to-text server are received, the texts could be displayed in real time. Exemplarily, it may be possible to display the texts from the voice-to-text server in all or part of areas of a display unit, to facilitate the conference participants viewing the converted texts and/or editing and correcting the converted texts.

In some embodiments, the conference recording method may further include the operation that the texts from the voice-to-text server may be stored. The storing operation may take place concurrently with the operation of displaying in real time, and may also take place before or after the operation of displaying in real time. In other embodiments, the storing operation may take place after the conference participants edit and correct the converted texts.

As could be seen from above, the conference recording method could realize automatic conversion and recording of the conference audio data by receiving the conference audio data copied by the conference sound box, transmitting it to the voice-to-text server for text conversion and receiving the converted texts, which could greatly improve work efficiency and reduce resource waste.

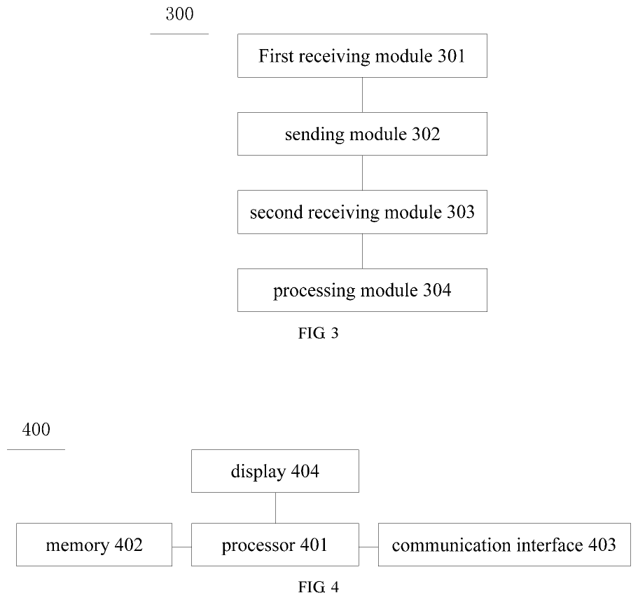

FIG. 3 is a schematic block diagram of a conference recording device according to an embodiment of the present disclosure. A conference recording device 300 shown in FIG. 3 may include a first receiving module 301, a sending module 302, a second receiving module 303, and a processing module 304.

The first receiving module 301 may be configured to receive conference audio data copied by the conference sound box. The first receiving module 301 could communicate to the conference sound box to receive the conference audio data copied by the conference sound box. Exemplarily, the conference audio data copied by the conference sound box may be transmitted through SPP, USB or Wifi.

The sending module 302 may be configured to send the conference audio data to a voice-to-text server for text conversion. The sending module 302 may communicate to the voice-to-text server to send the conference audio data to the voice-to-text server for text conversion. Exemplarily, the voice-to-text server could be disposed locally or in the cloud. Exemplarily, the voice-to-text server may be implemented based on an ASR (Automatic Speech Recognition technology) engine. The conference audio data copied by the conference sound box could be converted into texts via the voice-to-text server. Furthermore, the voice-to-text server may also perform processing of the converted texts, such as error correction, typesetting, marking (highlighting), and the like.

The second receiving module 303 may be configured to receive the texts from the voice-to-text server. The second receiving module 303 could receive the texts from the voice-to-text server by communicating with the voice-to-text server.

The processing module 304 may be configured to process the texts received from the voice-to-text server. As an example, the processing may include text correction and/or typesetting. The text error correction and/or typesetting could be implemented based on a local text processing engine or a third-party text processing engine. In other examples, the processing may further refer to performing extraction of key words or key segments from the texts to obtain key contents of the conference. The key words or key segments could be implemented via manual and/or automatic operations, for example, the key words could be inputted by a user, and the extraction of the key words and the key segments may be performed automatically.

Moreover, it should be understood that, after the voice-to-text server implements partial text processing, such as typesetting or error correction, the processing module 304 may simply implement processing of extracting of key words or key segments from the texts, to obtain the key contents of the conference, rather than implement the processing of typesetting or error correction. Of course, in other embodiments, the processing module 304 could also perform text correction and/or typesetting again.

In some embodiments, the processing module 304 may be further configured to analyze the conference audio data to distinguish and mark audio data of different conference participants, and mark texts into which the audio data of different conference participants has been converted. Exemplarily, by performing analysis of voiceprint, voice frequency, etc. of the audio data, it may be possible to distinguish whether each segment of audio in the conference audio data belongs to a same conference participant, and then to mark each segment of audio; and after the segment of audio is converted to texts, the segment of texts may be also marked, so that the user could make a distinction between speeches of different conference participants.

The conference recording device shown in FIG. 3 may be operable to implement the foregoing method shown in FIG. 2. Details may be not described herein again.

It could be seen that, the conference recording device could realize automatic conversion and recording of conference audio data by receiving the conference audio data copied by the conference sound box, transmitting it to a voice-to-text server for text conversion and receiving the converted texts, which could greatly improve work efficiency and reduce waste of resources.

FIG. 4 may be a schematic block diagram of a conference recording apparatus according to an embodiment of the present disclosure. A conference recording apparatus 400 shown in FIG. 4 may include a processor 401, a memory 402, a communication interface 403, and a display 404.

The processor 401 may include one or more central processing units (CPUs), graphics processing units (GPUs), application specific integrated circuits (ASICs), field programmable gate arrays (FPGAs), or combinations thereof. The processor 401 may be capable of executing software or computer-readable instructions or program codes stored in the memory 402 to perform the conference recording method or operations of the respective modules of the conference recording device described herein. The processor 401 could be implemented in a number of different ways. For example, the processor 401 could include one or more embedded processors, processor cores, microprocessors, logic circuits, hardware finite state machines (FSMs), digital signal processors (DSPs), or combinations thereof.

The memory 402 may be capable of storing software, data, logs, or combinations thereof, as well as various software or computer programs that could be executed or applied by the processor 401. The memory 402 could be an internal memory or an external memory. For example, the memory could be a volatile memory, for example, a static random access memory (SRAM), or a non-volatile memory, for example, a non-volatile random access memory (NVRAM), a flash memory, or a disk memory.

The communication interface 403 may be configured to implement communication to other apparatus, and to perform data transmission communication to other apparatus, such as the conference sound box or voice-to-text server. Exemplarily, in the present embodiment, the communication interface may be configured to receive conference audio data copied by the conference sound box, to send the conference audio data to a voice-to-text server for text conversion, and to receive texts from the voice-to-text server. The communication interface 403 may include one or more wired or wireless communication interfaces, such as a communication interface network interface card, a wireless modem, or a wired modem. In some applications, the communication interface 403 could be a WiFi modem. In other applications, the communication interface 403 could be a 3G modem, a 4G modem, an LTE modem, a Bluetooth component, a radio frequency receiver, a USB interface, an antenna, or combinations thereof.

The display 404 may be any type of display apparatus for displaying the texts received from the voice-to-text server.

The conference recording apparatus shown in FIG. 4 may be operable to implement the foregoing method shown in FIG. 2 and/or the conference recording device and its constituent modules shown in FIG. 3. Details may be not described herein again.

In addition, an embodiment of the present disclosure may further provide a computer storage medium having a computer program stored thereon. When the computer program is executed by a processor, it may be possible to implement the foregoing method shown in FIG. 2 or the respective constituent modules in the conference recording device shown in FIG. 3. For example, the computer storage medium may include, for example, a memory card of a smart phone, a storage component of a tablet computer, a hard disk of a personal computer, a read only memory (ROM), an erasable programmable read only memory (EPROM), a portable compact disk-read only memory (CD-ROM), a USB memory, or any combination of the above storage media. The computer readable storage medium could be any combination of one or more computer readable storage media.

In addition, embodiments of the present disclosure may further provide a conference recording system. The conference recording system may include a conference sound box and a conference recording apparatus according to the embodiments of the present disclosure. The conference sound box may be configured to acquire and play conference audio data and to copy the conference audio data; and the conference recording apparatus may be configured to receive the conference audio data from the conference sound box, to send the conference audio data to a voice-to-text server for text conversion, and to receive texts from the voice-to-text server to implement conference recording. Of course, in some embodiments, the conference recording system may further include a voice-to-text server for realizing voice-to-text conversion. Exemplarily, the conference recording apparatus may be a smart terminal, such as a smart phone, tablet, or a computer like a personal PC. The voice-to-text server could be implemented as a cloud server.

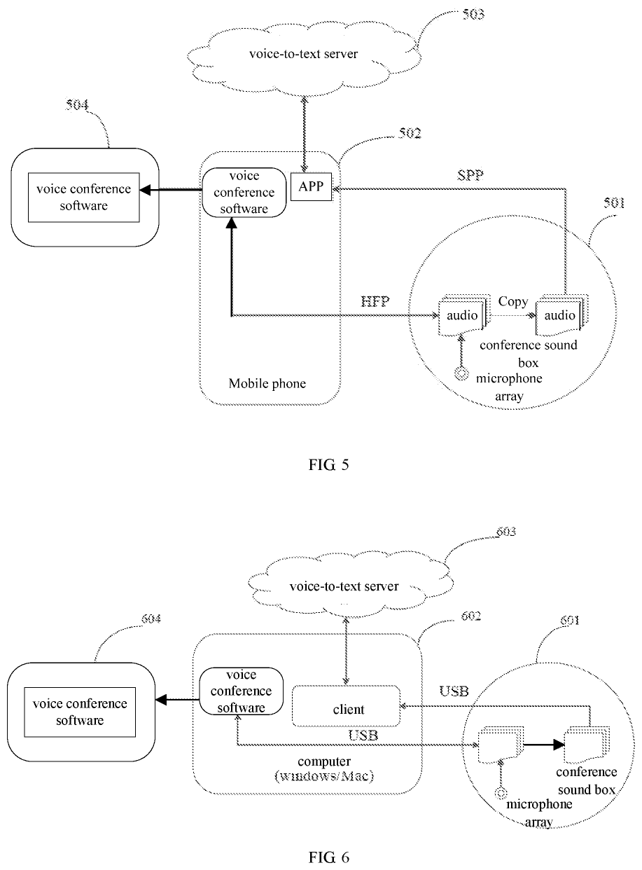

Use circumstances of a conference recording system according to embodiments of the present disclosure will be described below in conjunction with FIGS. 5 and 6.

FIG. 5 is a schematic diagram of a use circumstance of a conference recording system according to an embodiment of the present disclosure. As shown in FIG. 5, in the present embodiment, the conference recording system may include a conference sound box 501, a conference recording apparatus 502, and a voice-to-text server 503.

The conference sound box 501, which could implement acquisition and playing of conference audio data, may include, for example, a microphone array, a loudspeaker, a communication interface, a processor and the like. As an example, the conference sound box 501 may implement communication connection and data transmission to the conference recording apparatus 502 via Bluetooth. The conference sound box 501 could copy the acquired conference audio data and send copied conference audio data to the conference recording apparatus 502.

The conference recording apparatus 502 could be any type of electronic apparatus including a memory and a processor. Exemplarily, in the present embodiment, the conference recording apparatus 502 may be a smart phone having a wireless communication function, for example, Bluetooth. The conference recording apparatus 502 could run the program stored thereon to implement the aforementioned method shown in FIG. 2 and/or the conference recording device and its constituent modules shown in FIG. 3. Exemplarily, in some embodiments, the conference recording apparatus 502 may run an application (APP) thereon to implement functions of the conference recording device shown in FIG. 3. In addition, the conference recording apparatus 502 may also run the program stored thereon to implement a voice conference function, thereby performing a voice conference with other apparatus 504 that could implement the voice conference.

The voice-to-text server 503 may be configured to convert the conference audio data uploaded by the conference recording apparatus 502 into texts, and to transfer the texts to the conference recording apparatus 502 to realize automatic conversion and recording of the conference audio data. Exemplarily, in the present embodiment, the voice-to-text server 503, which may be a server disposed in the cloud, could implement communication and data transmission to the conference recording apparatus 502 through a wired or wireless network. Exemplarily, the voice-to-text server 503 may be a server based on an ASR engine.

Under the use circumstance of the conference recording system or the conference recording apparatus shown in FIG. 5, the conference recording apparatus 502 may communicate to the conference sound box 501 via Bluetooth, voice conference software run on the conference recording apparatus 502 may realize conference voice data transmission with the conference sound box 501 through an HFP protocol. An application run on the conference recording apparatus 502 for implementing the conference recording may receive conference audio data copied by the conference sound box 501 though SPP; and the conference audio data may be then uploaded to the voice-to-text server 503 for text conversion, followed by receiving the converted texts, and displaying the converted texts in real time, to facilitate the conference participants in realizing automatic recording of the conference.

FIG. 6 is a schematic diagram of another use circumstance of a conference recording system according to an embodiment of the present disclosure. In some embodiments, the conference recording system may include a conference sound box 601, a conference recording apparatus 602, and a voice-to-text server 603.

The conference sound box 601, which could implement acquisition and playing of conference audio data, may include, for example, a microphone array, a loudspeaker, a communication interface, a processor and the like. As an example, the conference sound box 601 may be capable of communicating with and transmitting data to the conference recording apparatus 602 via a USB interface. The conference sound box 601 could copy the acquired conference audio data and send it to the conference recording apparatus 602.

The conference recording apparatus 602 could be any type of electronic apparatus including a memory and a processor. Exemplarily, in some embodiments, the conference recording apparatus 602 may be a computer, such as any type of PC using a windows or mac system, which has a USB connection function. The conference recording apparatus 602 could run a program stored thereon to implement the aforementioned method shown in FIG. 2 and/or the conference recording device and its constituent modules shown in FIG. 3. Exemplarily, in some embodiments, the conference recording apparatus 602 may run a client thereon to implement functions of the conference recording device shown in FIG. 3. In addition, the conference recording apparatus 602 could also run the program stored thereon to implement a voice conference function, thereby performing a voice conference with other apparatus 604 that could implement the voice conference.

The voice-to-text server 603 may be configured to convert the conference audio data uploaded by the conference recording apparatus 602 into texts and then to transfer the texts to the conference recording apparatus 602 to realize automatic conversion and recording of the conference audio data. Exemplarily, in the present embodiment, the voice-to-text server 603, which may be a server disposed in the cloud, could implement communication and data transmission to the conference recording apparatus 602 through a wired or wireless network. Exemplarily, the voice-to-text server 603 may be a server based on an ASR engine.

Under the use circumstance of the conference recording system or conference recording apparatus shown in FIG. 6, the conference recording apparatus 602 may communicate to the conference sound box 601 via USB. Voice conference software run on the conference recording apparatus 602 may realize conference voice data transmission to the conference sound box 601 through USB. A client run on the conference recording apparatus 602 for implementing the conference recording may receive the conference audio data copied by the conference sound box 601 via USB. The conference audio data may be uploaded to the voice-to-text server 603 for text conversion, followed by receiving the converted texts, and displaying the converted texts in real time, to facilitate the conference participants in realizing automatic recording of the conference.

It should be understood that, the use circumstance of the conference recording system shown in FIG. 5 or FIG. 6 may be merely exemplary. For example, the conference recording apparatus may be not limited to a smart phone or a PC, but may be other type of electronic apparatus having a processor and a memory, for example, a tablet computer, any type of audio and video conference system, or the like. Moreover, communication between the conference recording apparatus and the conference sound box may be not limited to Bluetooth or USB, and may be other form such as Wifi, mobile communication (3G or 4G, etc.) and other suitable data communication transmission technology.

It should also be understood that, the conference recording system according to the embodiments of the present disclosure may be not limited to the above use circumstances, for example, could also be applied to a circumstance of using an audio and video conference system for a conference, in which circumstance the conference may be no longer made via voice conference software, that is, the conference recording apparatus shown in FIG. 5 or 6 may be used only for conference recording. For another example, the conference recording system according to embodiments of the present disclosure may also be used for a local conference, where no remote party participating in the conference through conference system or voice conference software may be involved. In this case, the conference sound box may be configured to acquire and play conference voice data of the local conference participants, copy and send the conference voice data to the conference recording apparatus for subsequent operations. The conference sound box, the conference recording method, apparatus, system and the computer storage medium according to the embodiments of the present disclosure could realize automatic conversion and recording of the conference voices by uploading the conference audio data copied by the conference sound box to a voice-to-text server for text conversion, and using the voice-to-text server to conveniently realize text conversion of the conference voices, which could greatly improve work efficiency and reduce waste of resources.

Although exemplary embodiments have been described herein with reference to the accompanying drawings, it should be understood that, the foregoing exemplary embodiments may be only exemplary, and may be not intended to limit the scope of the present disclosure thereto. Those of ordinary skill in the art could make various changes and modifications thereto without departing from the scope and spirit of the present disclosure. All such changes and modifications may be intended to be included within the scope of the present disclosure as claimed in the appended claims.

Those ordinarily skilled in the art could realize that, units and algorithm steps of various examples described in conjunction with the embodiments disclosed herein could be implemented via electronic hardware or a combination of computer software and electronic hardware. Whether these functions may be performed via hardware or software depends on specific application and design constraint conditions of the technical solution. A person skilled in the art could use different methods for each specific application to implement the described functions, but such implementation should not be considered as exceeding the scope of the present disclosure.

In the embodiments provided by the present disclosure, it should be understood that, the disclosed apparatus and method may be implemented in other manners. For example, the apparatus embodiments described above may be merely exemplary. For example, division of the units may be nothing but division of logical functions. In actual implementation, there could be other manner of division, for example, multiple units or components may be combined or may be integrated into another apparatus, or some features could be ignored or not be executed.

In the description provided herein, numerous specific details may be set forth. However, it could be understood that the embodiments of the present disclosure may be practiced without these specific details. In some instances, well-known methods, structures, and techniques may be not shown in detail so as not to obscure understanding of the present description.

Similarly, it should be understood that, in order to make the present disclosure concise and help understand one or more of various aspects of the present disclosure, various features of the present disclosure may be sometimes grouped together into a single embodiment, figure or description thereof in the description of exemplary embodiments of the present disclosure. However, the method of the present disclosure should not be construed as reflecting the intention that the claimed invention requires more features than those expressly recited in each of the appended claims. More precisely, as reflected by the corresponding claims, the inventive point thereof lies in that it may be allowed to use features less than all features of a certain single embodiment disclosed to solve the technical problem concerned. Therefore, the claims which conform to specific embodiments may be hereby explicitly incorporated into the specific embodiments, where each of the claims per se serves as a separate embodiment of the present disclosure.

It could be understood by those skilled in the art that, except for mutual exclusiveness between features, it may be possible to adopt any combination to combine all features disclosed by the present description (including the appended claims, abstract and drawings) and all procedures or units of any method or apparatus disclosed thereby. Unless stated otherwise, each feature disclosed by the present description (including the appended claims, abstract and drawings) could be substituted by substitutive features providing identical, equivalent or similar purposes.

In addition, those skilled in the art could understand that, although some embodiments described herein include certain features included in other embodiments, rather than other features, combinations of features of different embodiments mean falling within the scope of the present disclosure and forming different embodiments. For example, in the claims, any one of the claimed embodiments could be used in any combination.

The various component embodiments of the present disclosure may be implemented via hardware, or via software modules run on one or more processors, or via a combination thereof. Those skilled in the art should understand that, a microprocessor or digital signal processor (DSP) may be used in practice to implement some or all of functions of some modules in an article analysis apparatus according to the embodiment of the present disclosure. The present disclosure could also be implemented as some or all of device programs (e.g., computer programs and a computer program product) for performing the method described herein. Such programs implementing the present disclosure may be stored on a computer-readable medium or may be in the form of one or more signals. Such signals may be downloaded from an Internet website, provided on a carrier signal, or provided in any other form.

It should be noted that, the above-described embodiments explain the present disclosure and may be not intended to limit the present disclosure. Moreover, those skilled in the art could design alternative embodiments without departing from the scope of the appended claims. In the claims, any parenthesized reference signs shall not be construed as limitations on the claims. The word “comprising” does not exclude presence of elements or steps not listed in the claims. The word “a/an” or “one” preceding the elements does not exclude presence of more than one such element. The present disclosure could be implemented by means of hardware comprising several distinct elements and by means of a suitably programmed computer. In the unit claims enumerating several devices, some of these devices could be specifically embodied by a same hardware item. Use of the words “first, second, third and the like” does not indicate any order. These words could be interpreted as names.

The foregoing may be only specific embodiments of the present disclosure or the description of the specific embodiments, and the protection scope of the present disclosure may be not limited thereto. Any person skilled in the art could easily conceive of changes or substitutions within the technical scope disclosed by the present disclosure, all falling within the protection scope of the present disclosure. The protection scope of the present disclosure shall be based on the protection scope of the claims.

What is claimed is:

1. A conference sound box capable of communicating to a conference recording device, comprising:
an audio acquisition module, configured to acquire conference audio data;
an audio playing module, configured to play the conference audio data;
a processor, configured to process the conference audio data and to copy the processed conference audio data; and
a communication interface, configured to send the processed conference audio data to the conference recording device;
wherein the conference recording device is configured to send the processed conference audio data to a voice-to-text server for text conversion and to receive texts from the voice-to-text server to implement conference recording.

2. The conference sound box according to claim 1, wherein the conference sound box communicates to the conference recording device via Bluetooth, Wifi or USB.

3. A conference recording method, comprising:
receiving conference audio data copied by a conference sound box;
sending the conference audio data to a voice-to-text server for text conversion; and
receiving texts from the voice-to-text server.

4. The conference recording method according to claim 3, further comprising:
processing the texts, the processing comprising text correction and/or typesetting.

5. The conference recording method according to claim 4, wherein the processing further comprises:
extracting key words or key segments from the texts to obtain key contents of the conference.

6. The conference recording method according to claim 3, further comprising:
analyzing the conference audio data to distinguish and mark audio data of different conference participants.

7. The conference recording method according to claim 6, further comprising:
marking texts into which the audio data of different conference participants has been converted.

8. A conference recording apparatus, comprising:
one or more processors; and
a memory storing one or more programs;
wherein the one or more programs, when executed by the one or more processors, cause the one or more processors to:
receive conference audio data copied by a conference sound box;
send the conference audio data to a voice-to-text server for text conversion; and
receive texts from the voice-to-text server.

9. The conference recording apparatus according to claim 8, wherein the one or more processors are further configured to:
process the texts, wherein the processing comprising text correction and/or typesetting.

10. The conference recording apparatus according to claim 9, wherein the processing further comprises:
extracting key words or key segments from the texts to obtain key contents of the conference.

11. The conference recording apparatus according to claim 8, wherein the one or more processors are further configured to:
analyze the conference audio data to distinguish and mark audio data of different conference participants.

12. The conference recording apparatus according to claim 11, wherein the one or more processors are further configured to:
mark texts into which the audio data of different conference participants has been converted.
